(19) United States
(12) Patent Application Publication
(10) Pub. No.: US 2012/0192561 A1
(43) Pub. Date: Aug. 2, 2012

(54) Combination spherical rotary valve internal combustion engine and steam engine incorporating scrubber capabilities on internal combustion engine exhaust

(76) Inventor: George J. Coates, Wall, NJ (US)

(21) Appl. No.: 13/374,188

(22) Filed: Dec. 16, 2011

Related U.S. Application Data
(60) Provisional application No. 61/459,778, filed on Dec. 20, 2010.

(51) Int. Cl. F01L 7/10; F02G 1/00

(52) U.S. Cl. 60/616; 123/190.14

(57) ABSTRACT

An internal combustion engine operating on spherical rotary valves in combination with a steam engine driven by the exhaust heat of the internal combustion engine, both engines are utilized to generate electricity, a portion of the waste steam is also utilized to scrub the pollutants from the exhaust of the internal combustion engine prior to its introduction to the ambient atmosphere.

### RELATED APPLICATIONS

Applicant claims the benefit of provisional application Ser. No. 61/459,778, filed Dec. 20, 2010.

### BACKGROUND OF THE INVENTION

1. Field of the Invention

The present invention relates to an internal combustion engine operating on spherical rotary valves in combination with a steam engine driven by the exhaust heat of an internal combustion engine, both engines are utilized to generate electricity, a portion of the waste steam is then utilized to scrub the exhaust from the internal combustion engine.

2. Description of the Prior Art

Applicant is the holder of a plurality of patents directed to internal combustion engines which operate with spherical rotary intake and exhaust valves. The spherical rotary valve system has advantages over the poppet valve system in that the spherical rotary valve system allows an engine to operate on a variety of alternative fuels, including natural gas, for which the poppet valve system is ill suited.

The Applicant herein has directed considerable attention to the internal combustion engine of the piston-cylinder type and in particular to the replacement of the poppet valve system, including the poppet valve, springs, mountings and associated cam shaft, with a spherical rotary valve assembly for the introduction of the fuel air mixture into the cylinder and for the evacuation of the exhaust gases. Applicant is the named inventor in U.S. Pat. No. 4,989,576, “Internal Combustion Engine”; U.S. Pat. No. 4,944,261, “Spherical Rotary Valve Assembly for Internal Combustion Engine”; U.S. Pat. No. 4,953,527, “Spherical Rotary Valve Assembly for Internal Combustion Engine”; U.S. Pat. No. 4,976,232, “Valve Seal for Rotary Valve Engine”; U.S. Pat. No. 4,989,558, “Spherical Rotary Valve Assembly for Internal Combustion Engine”; U.S. Pat. No. 5,109,814, “Spherical Rotary Valve”; and U.S. Pat. No. 5,361,739, “Spherical Rotary Valve Assembly for Use in a Rotary Valve Internal Combustion Engine”. The aforementioned U.S. Patents are incorporated herein as if set forth in length and in detail.

Applicant has developed an internal combustion engine operating on spherical rotary valves which operates on an oil well head, and runs on the spent natural gas emitted from the oil well head to generate electricity which is fed to a power grid. Oil companies in many jurisdictions are not allowed to burn off this natural gas which often times is high in sulphur content because of environmental concerns. Applicant has now further refined this system to utilize the exhaust gases heat of the internal combustion engine running on natural gas to heat a steam boiler/heat exchanger for the generation of steam pressure which will simultaneously run a CSRV steam engine which itself will power a generator for the generation of additional electric power to be fed to the power grid. Further, a portion of the steam waste generated may be introduced into the ultimate exhaust gases from the combustion engine to further scrub and clean these exhaust gases before their introduction into the atmosphere.

### OBJECTS OF THE INVENTION

An object of the present invention is to provide for a novel generation source incorporating and coupling an internal combustion engine and steam engine, the steam engine being powered by the exhaust heat of the internal combustion engine.

Another object of the present invention is to provide for a novel power source wherein the exhaust of the internal combustion engine may be scrubbed to remove pollutants before accessing the ambient atmosphere by means of excess steam bled from the steam engine.

A still further object of the present invention is to provide for a novel power source combining an internal combustion engine and a steam engine powered by the heat of the exhaust of the internal combustion engine to rotate generators in order to generate electricity.

A still further object of the present invention is to provide for a novel internal combustion engine operating on spherical rotary valves, which is fueled by the raw spent natural gas emitted from an oil well head, the internal combustion engine utilized to drive a turbine to generate electricity, the spent exhaust gases of the internal combustion engine used to heat a steam boiler/heat exchanger for the generation of steam pressure which simultaneously runs a spherical rotary valve steam engine, which itself further generates additional electric power.

### SUMMARY OF THE INVENTION

An internal combustion engine operating on spherical rotary valves in combination with a steam engine driven by the exhaust heat of the internal combustion engine, both engines are utilized to generate electricity, a portion of the waste steam is also utilized to scrub the pollutants from the exhaust of the internal combustion engine prior to its introduction to the ambient atmosphere.

### BRIEF DESCRIPTION OF THE DRAWINGS

These and other objects of the present invention will become apparent, particularly when taken in light of the following illustrations wherein:

FIG. 1 is a schematic view of the internal combustion engine boiler steam engine arrangement of the present invention.

### DETAILED DESCRIPTION OF THE INVENTION

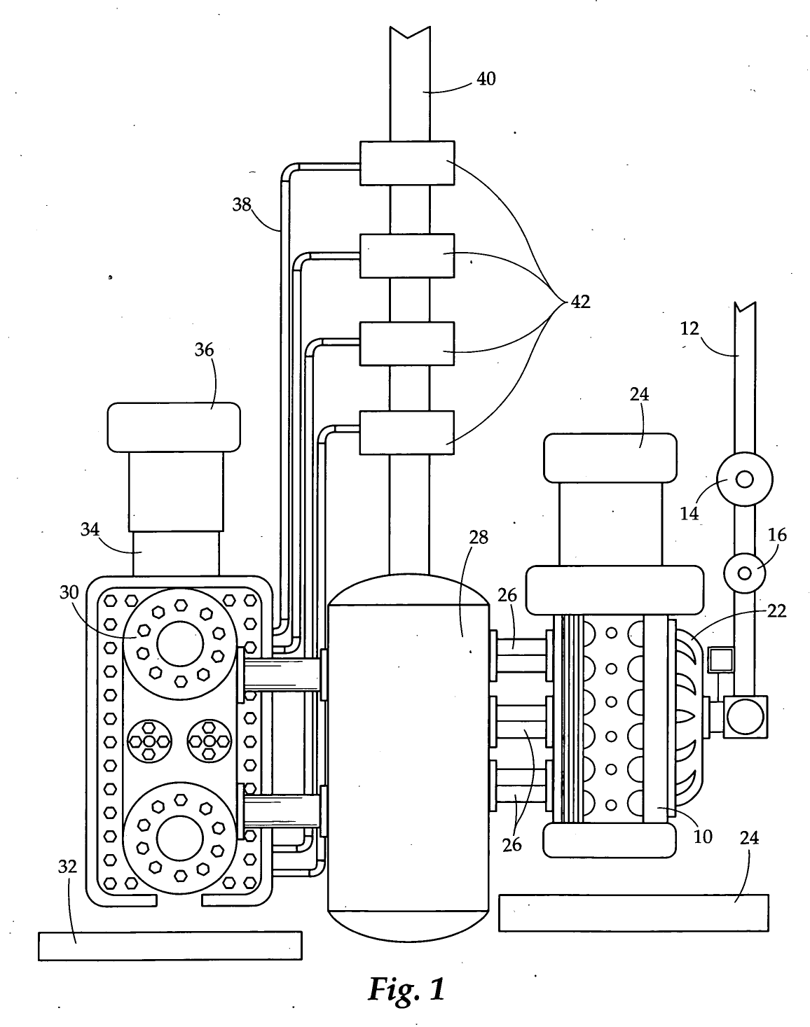

FIG. 1 is a top view of the arrangement of a combination spherical rotary valve internal combustion engine, with steam engine, incorporating a scrubber means. The internal combustion engine 10 is preferably a spherical rotary valve engine which allows the engine to operate on alternative fuels, such as natural gas, bio-fuels, and the like, which can be deleterious to a poppet valve engine over time. The fuel to the internal combustion engine 10 is introduced by a conduit 12 and is subjected to a fuel pressure control 14, a fuel regulator 16, and a fuel mixer 18 if a mixture of alternative fuels is being used. A combustion engine governor 20 regulates the fuel to the internal combustion engine 10 by way if intake manifold 22. A radiator 24 is secured to the front of the internal combustion engine 10 to regular engine temperature. The combustion in the internal combustion engine 10 is utilized to drive an electric power generator 24.

The exhaust from the internal combustion engine 10 is directed via exhaust manifolds 26 to a steam flash boiler 28. The steam boiler 28 is of a heat exchanger type with a circuitous path within which the exhaust gases from the internal combustion engine 10 are circulated in order to heat the water passing through the tubes of the heat exchanger. Steam is created at approximately 350° F. and upward, and steam engines operate from a temperature o 350° F. to 600° F. at about 150 pounds per square inch constant tank pressure. The exhaust temperature of the internal combustion engine gases is between 900° F. and 1100° F. The steam boiler 28 is directly attached to the steam chest of a steam piston spherical rotary intake and exhaust valve engine 30 which converts the steam pressure into kinetic energy. The steam engine's kinetic energy is maintained by a fly wheel 32 to insure constant and even rotation. The steam engine 30 is connected by a steam engine governor 34, to a second electric power generator 36 for generating electricity.

This arrangement further allows for the scrubbing of the exhaust gases which exit the steam boiler 28. A portion of the steam not condensed and recirculated to the steam boiler 28 is directed via conduits 38 to the exhaust conduit 40 attached to the steam boiler 28 through which the original exhaust gases from the internal combustion engine exit. A series of scrubbers 42 in this exhaust line allow the portion of excess steam from the steam engine 38 to be introduced into exhaust line 40 to capture and remove pollutants to be regathered in a liquid state.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

I claim:

1. The system for the generation of electrical power from the combustion of untreated spent natural gas emanating from an oil well, the system comprising:
an internal combustion engine having spherical rotary valves, said internal combustion engine powered by spent, untreated natural gas, which is a byproduct of an oil well, said internal combustion engine powering a generator for the production of electricity;
a steam flash boiler of the circuitous heat exchange type in communication with exhaust manifolds from said internal combustion engine, said heated exhaust gases from said internal combustion engine heating water in the said steam flash boiler generating steam;
a steam piston engine utilizing spherical rotary valves in communication with said steam boiler, said steam generated in said steam boiler powering said steam piston engine generating kinetic energy maintained by a flywheel, said kinetic energy utilized to power a second electrical power generator for the generation of electricity.

2. The system for the generation of electrical power in accordance with claim 1 wherein a portion of said steam exiting said steam piston engine is redirected to a plurality of scrubbers positioned said exhaust gas line from said steam flash boiler to further remove impurities and pollutants from said exhaust gases.

3. The system for generating electrical power in accordance with claim 1 wherein said spherical rotary valve assembly comprises:
a removable two piece cylinder head securable to an internal combustion engine block, said two piece removable cylinder head comprising an upper and lower cylinder head section; said upper and lower cylinder head sections, when secured to said internal combustion engine block define two cavities radially aligned with the cylinders of said internal combustion engine, said cavities defining a plurality of first drum accommodating cavities for receipt of radially-aligned rotary intake valves and second radially-aligned cavities defining a plurality of second drum accommodating cavities for receipt of a plurality of radially-aligned rotary exhaust valves, said lower cylinder head section and said plurality of first drum accommodating cavities having an inlet port in communication with said cylinder; said lower cylinder head section and said second drum accommodating cavities having an outlet port in communication with said cylinder; said spherical rotary valve assembly further having a sealing means associated with said inlet and said outlet ports and a first passageway for introduction of a fuel/air mixture into said cylinder head by way of a reservoir cavity adjacent both sides of said first drum accommodating cavity and said rotary intake valve and a second passageway for evacuation of exhaust gases from said cylinder by way of an evacuation cavity adjacent both sides of said second drum accommodating cavity and said rotary exhaust valve; said spherical rotary valve assembly further having a first shaft means journaled on bearing surfaces within said first cavity, radially aligned with said cylinders of said internal combustion engine, said first shaft means having mounted thereon a plurality of said rotary intake valves; and a second shaft means journaled on said bearing surfaces within said second radially aligned cavity, said second shaft means having positioned thereon a plurality of rotary exhaust valves; said rotary intake valve and said rotary exhaust valve each having a spherical section defined by two parallel planes of a sphere, said planes being disposed symmetrically about the center of said sphere defining a spherical periphery and planar side walls said rotary intake valves mounted on said first shaft means and said plurality of drum accommodating cavities in gas sealing contact with said inlet port, said rotary exhaust valves mounted on said second shaft means in said plurality of drum accommodating cavities in gas tight sealing contact with said outlet port, said rotary exhaust valve having a passageway positioned on its spherical periphery for the evacuation and interruption of evacuation of exhaust gases from said cylinder, said rotary exhaust valve having doughnut-shaped cavities formed on said planar side walls in communication with said passageway on said spherical periphery, said doughnut cavities in communication with adjacent evacuation cavities formed in said upper and lower cylinder head sections, said adjacent evacuation cavities in communication with said second passageway for the evacuation of exhaust gases from said cylinder.
